(19) United States
(12) Patent Application Publication
(10) Pub. No.: US 2008/0018081 A1
(43) Pub. Date: Jan. 24, 2008

(54) AIR BAG MODULE FOR VEHICLES

(75) Inventors: Ho Jun YANG, Gyeonggi-do (KR); Kwang Seob SHIN, Gyeonggi-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/757,693

(22) Filed: Jun. 4, 2007

(30) Foreign Application Priority Data
Jul. 24, 2006 (KR) 10-2006-0069296
Aug. 24, 2006 (KR) 10- 2006-0080770
Nov. 16, 2006 (KR) 10-2006-0113553

(51) Int. Cl. B60R 21/20

(52) U.S. Cl. 280/728.2

(57) ABSTRACT

Disclosed is an air bag module for vehicles, which has a simple mounting structure so as to reduce the number of parts, and is easily installed. The air bag module for vehicles includes an instrument panel provided with a receipt hole formed therethrough; an air bag door installed at the receipt hole; an air bag housing, into which an air bag is put, installed in the receipt hole; an extension portion protruded from the air bag door to the inside of the receipt hole; a connection unit installed between the extension portion and the air bag housing for connecting the air bag door and the air bag housing; and a mounting unit installed between the air bag door and the receipt hole for fastening the air bag door in the receipt hole.

### BACKGROUND OF THE INVENTION

1. Field of the Invention

The present invention relates to an air bag module for vehicles, and more particularly to an air bag module for vehicles, which has a simple mounting structure so as to reduce the number of parts, and is easily installed.

2. Description of the Related Art

FIG. 1 is a perspective view illustrating the inside of a general vehicle, and FIG. 2 is a longitudinal-sectional view taken along the line A-A of FIG. 1, illustrating a conventional air bag module for vehicles.

With reference to FIGS. 1 and 2, a conventional air bag module for vehicles includes a door 20 installed on an instrument panel 10, an air bag 32 installed in the door 20 and protruded from the outside of the door 20 when a vehicle collision occurs so as to expand in volume, and an air bag housing 30, into which the air bag 32 is put, mounted on the inner surface of the instrument panel 10 and causing the air bag door 20 to be connected thereto.

The air bag door 20 is installed at a receipt hole 12 of the instrument panel 10. A bracket 22 is installed on the outer wall of the edge of the receipt hole 12, one end of the air bag door 20 is interposed between the bracket 22 and the receipt hole 12, and the air bag housing 20 is disposed on the inner wall of the receipt hole 12.

Bolts (B) are fastened to portions of the bracket 22, the air bag door 20, the receipt hole 12, and the air bag housing 30, which are stacked, thereby allowing the air bag module to be installed. The other end of the air bag door 20 is not interposed between the bracket 22 and the receipt hole 12, so as to be opened when the air bag 32 is protruded from the outside of the door 20.

Since the connection of the air bag door 20 and the air bag housing 30 is achieved by the bolts (B), the above conventional air bag module for vehicles requires the bracket 22 installed for improving the rigidity of the connection portion between the air bag door 20 and the air bag housing 30, thus causing a difficulty in reducing the number of parts required to install the air bag module. Further, the above conventional air bag module for vehicles has a complicated mounting structure, thus causing a difficulty in reducing the time and cost required to install the air bag module.

### SUMMARY OF THE INVENTION

Therefore, the present invention has been made in view of the above problems, and it is an object of the present invention to provide an air bag module for vehicles, which has an improved mounting structure, so as to reduce the number of parts required to install the air bag module and reduce the time and cost required to install the air bag module.

It is another object of the present invention to provide an air bag module for vehicles, which: expands and contracts, so as to prevent an instrument panel from being deformed and damaged due to expansion and contraction according to a variation of temperature.

It is yet another object of the present invention to provide an air bag module for vehicles, which improves the strength of an air bag door, so as to prevent the air bag door from being deformed and damaged.

In accordance with the present invention, the above and other objects can be accomplished by the provision of an air bag module for vehicles comprising an instrument panel provided with a receipt hole formed therethrough; an air bag door installed at the receipt hole; an air bag housing, into which an air bag is put, installed in the receipt hole; an extension portion protruded from the air bag door to the inside of the receipt hole; a connection unit installed between the extension portion and the air bag housing for connecting the air bag door and the air bag housing; and a mounting unit installed between the air bag door and the receipt hole for fastening the air bag door in the receipt hole.

A plurality of crease portions, which is concave, may be formed in the upper surface of the air bag door.

The air bag module may further comprise fracture holes causing the air bag door to be torn off, when the air bag is spread; and a reinforcing member over-molded on the upper or lower surface of the air bag door so as to increase the rigidity of the air bag door and prevent the deformation of the air bag door.

The reinforcing member may be made of a metal.

Extension members may be extended integrally from the reinforcing member, and be insert injection molded under the condition that they are inserted into the fracture holes so as to prevent the spontaneous separation of the reinforcing member and the air bag door.

Seam lines may be caved in the air bag door between the neighboring fracture holes; and bending members may be extended integrally from the reinforcing member, and be insert injection molded under the condition that they are inserted into the seam lines so as to prevent the spontaneous separation of the reinforcing member and the air bag door.

The mounting unit may include a protrusion obtained by inwardly bending the edge of the receipt hole, and a hook installed around the extension portion corresponding to the protrusion.

The connection unit may include connection holes formed through the lower end of the extension portion, and connection protrusions formed on the air bag housing corresponding to the connection holes and inserted into the connection holes.

The connection unit may include fastening pieces rotatably installed at the end of the air bag housing, coil springs installed on rotary shafts of the fastening pieces, and fastening holes formed through the inner wall of the air bag door corresponding to the fastening pieces.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating the inside of a general vehicle;

FIG. 2 is a longitudinal-sectional view taken along the line A-A of FIG. 1, illustrating a conventional air bag module for vehicles;

FIG. 3 is a longitudinal-sectional view of an air bag module for vehicles in accordance with a first embodiment of the present invention;

FIG. 4 is a perspective view of a door of the air bag module for vehicles in accordance with the first embodiment of the present invention;

FIG. 5 is a longitudinal-sectional view of an air bag module for vehicles in accordance with a second embodiment of the present invention;

FIG. 6 is an exploded longitudinal-sectional view of the air bag module for vehicles in accordance with the second embodiment of the present invention;

FIG. 7 is a longitudinal-sectional view of an air bag module for vehicles in accordance with a third embodiment of the present invention;

FIG. 8 is a perspective view of an essential portion of a door of the air bag module for vehicles in accordance with the third embodiment of the present invention;

FIG. 9 is an exploded perspective view of FIG. 8;

FIG. 10 is a longitudinal-sectional view taken along the line A-A of FIG. 8; and

FIG. 11 is a longitudinal-sectional view taken along the line B-B of FIG. 8.

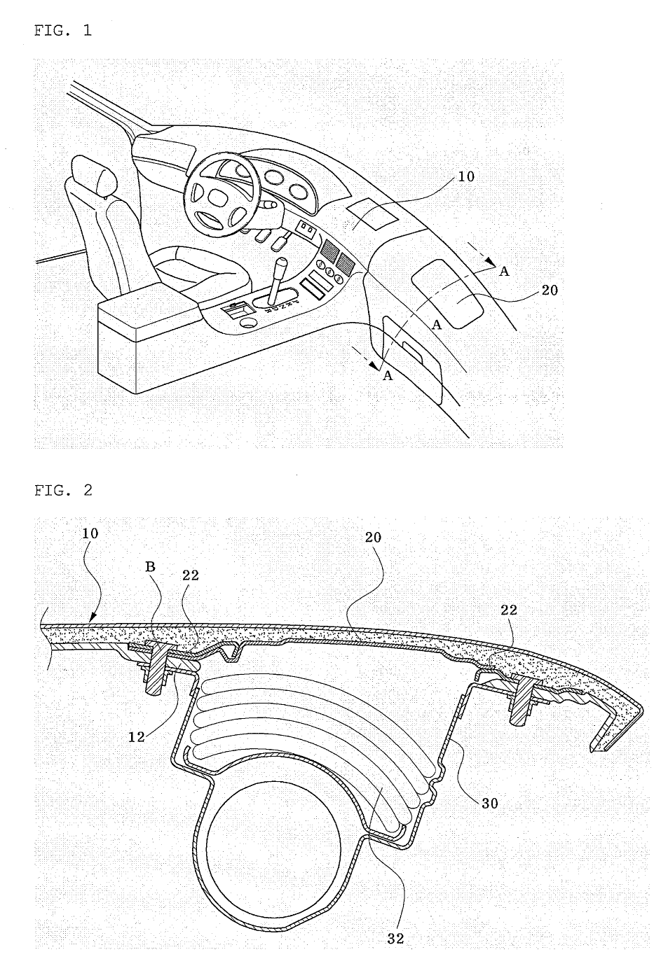

### DESCRIPTION OF THE PREFERRED EMBODIMENTS

Now, preferred embodiments of the present invention will be described in detail with reference to the annexed drawings.

For convenience of explanation, an air bag module for vehicles will be exemplarily described. Here, thicknesses of lines illustrated in the drawings or sizes of elements may be exaggerated for clarity and convenience of explanation.

Further, terms, which will be described later, are defined in consideration of functions in the present invention, and may be varied according to intentions of users or usual practice.

Accordingly, the terms must be defined based on the overall content of the description of the present invention.

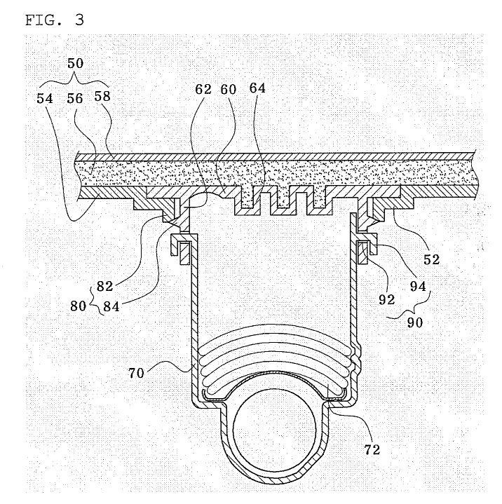

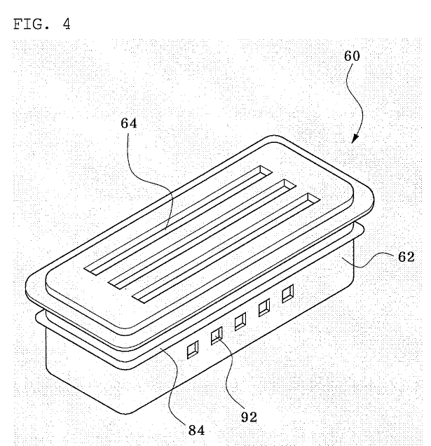

FIG. 3 is a longitudinal-sectional view of an air bag module for vehicles in accordance with a first embodiment of the present invention, and FIG. 4 is a perspective view of a door of the air bag module for vehicles in accordance with the first embodiment of the present invention.

With reference to FIGS. 3 and 4, an air bag module for vehicles in accordance with the first embodiment includes an instrument panel 50 provided with a receipt hole 52 formed therethrough, an air bag door 60 installed at the receipt hole 52, an air bag housing 70, into which an air bag 72 is put, installed in the receipt hole 52, an extension portion 62 protruded from the air bag door 60 to the inside of the receipt hole 52, a connection unit 90 installed between the extension portion 62 and the air bag housing 70 for connecting the air bag door 60 and the air bag housing 70, and a mounting unit 80 installed between the air bag door 60 and the receipt hole 52 for fastening the air bag door 60 in the receipt hole 52.

After the air bag housing 70, into which the air bag 72 is put, and the air bag door 60 is connected by the connection unit 90, the air bag door 60 is mounted on the receipt hole 52 formed through an internal panel 54 of the instrument panel 50 by the: mounting unit 80, and a foaming agent layer 56 and an external panel 58 are formed on an outer wall composed of the internal panel 54 and the air bag door 60. Thereby, the instrument panel 50 and the air bag module are installed.

A plurality of crease portions 64, which is concave, is formed in the upper surface of the air bag door 60. Thus, the air bag door 60 efficiently expands and contracts corresponding to the expansion and contraction of the instrument panel 50 according to a variation of temperature, thereby preventing the area of the instrument panel 50, in which the air bag door 60 is disposed, from being convexly or concavely deformed.

The mounting unit 80 includes a protrusion 82 obtained by inwardly bending the edge of the receipt hole 52, and a hook 84 installed around the extension portion 62 corresponding to the protrusion 82.

The connection unit 90 includes connection holes 92 formed through the lower end of the extension portion 62, and connection protrusions 94 formed on the air bag housing 70 corresponding to the connection holes 92 and inserted to the connection holes 92.

Thereby, when the upper end of the air bag housing 70 is inserted into the extension portion 62 of the air bag door 60, a designated quantity of the upper end of the air bag housing 70 is deformed inwardly and slid to the inside of extension portion 62. Then, when the connection protrusions 94 reach positions corresponding to the connection holes 92, the air bag housing 70 is restored to its initial state, and the connection protrusions 94 are inserted into the connection holes 92, thereby connecting the air bag door 60 and the air bag housing 70.

Thereafter, when the air bag door 60 and the air bag housing 70 are inserted into the receipt hole 52, designated quantities of the extension portion 62 and the air bag housing 70, which are respectively made of synthetic resins, are deformed and slid to the inside of the receipt hole 52. Then, when the hook 84 is caught on the protrusion 82, the extension portion 62 and the air bag housing 70 are restored to their initial states, thereby mounting the air bag door 60 and the air bag housing 70 on the instrument panel 50.

Hereinafter, the operation of the above air bag module for vehicles in accordance with the first embodiment of the present invention will be described.

First, when the air bag housing 70 made of a synthetic resin is inserted into the air bag door 60 made of a synthetic resin, designated quantities of the air bag housing 70 and the air bag door 60 are deformed, and the connection protrusions 94 are inserted into the connection holes 92. Thereby, the air bag door 60 and the air bag housing 70 are connected.

When the air bag door 60 and the air bag housing 70, which are connected in the above manner, are inserted into the receipt hole 52 formed through the internal panel 54 of the instrument panel 50 made of a metal, designated quantities of the extension portion 62 and the air bag housing 70 are deformed, and the hook 84 is caught on the protrusion 82. Thereby, the air bag door 60 and the air bag housing 70 are mounted on the instrument panel 50.

Thereafter, the foaming agent layer 56 and the external panel 58 are formed on the outer wall composed of the internal panel 54 and the air bag door 60. Thereby, the installation of the air bag module is completed.

Generally, a groove (not shown) having a similar shape to that of the air bag door 60 is formed in the area of the external panel 58, at which the air bag door 60 is located, so that the external panel 58 is easily cut along the groove when the air bag door 60 is opened.

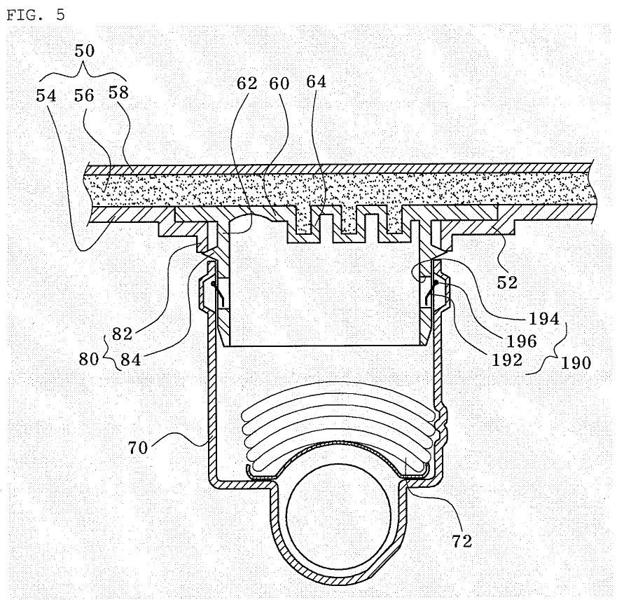

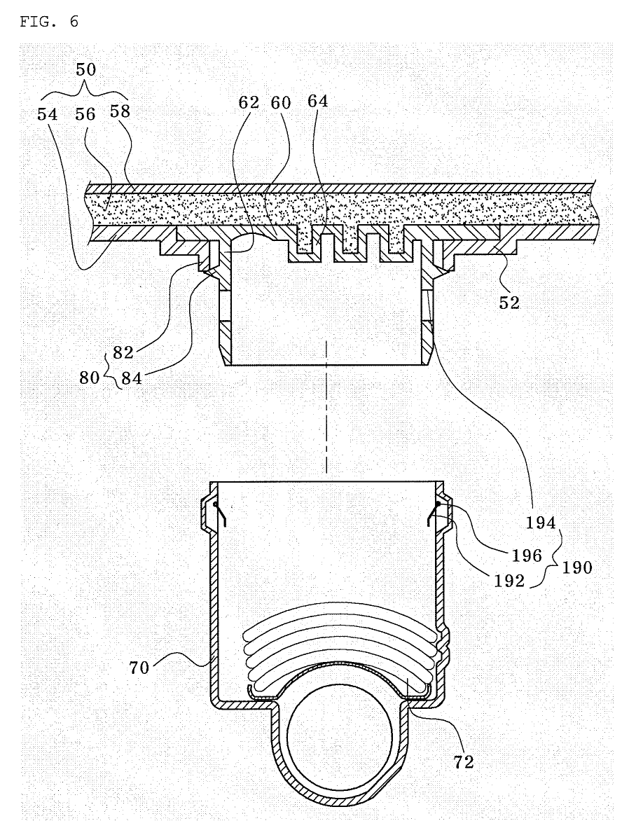

FIG. 5 is a longitudinal-sectional view of an air bag module for vehicles in accordance with a second embodiment of the present invention, and FIG. 6 is an exploded longitudinal-sectional view of the air bag module for vehicles in accordance with the second embodiment of the present invention.

With reference to FIGS. 5 and 6, an air bag module for vehicles in accordance with the second embodiment is characterized in a connection unit 190, compared with the air bag module for vehicles of the first embodiment.

The connection unit 190 of the air bag module for vehicles of the second embodiment includes fastening pieces 192 :rotatably installed at the end of the air bag housing 70, coil :springs 196 installed on rotary shafts of the fastening pieces -192, and fastening holes 194 formed through the inner wall of the air bag door 60 corresponding to the fastening pieces 192.

Here, the fastening pieces 192 have a panel shape inclined to the inside of the air bag housing 70 at a designated angle, and are provided with a curved portion at the ends thereof corresponding to the fastening holes 194.

When the air bag housing 70 is slid to the fastening holes 194, the curved portions contact the fastening holes 194 and rotate the fastening pieces 192, and the coil springs 196 are compressed. Then, the fastening pieces 192 are rotated to the outside of the air bag housing 70, and reach a state that the air bag housing 70 can be inserted into the air bag door 60.

Thereafter, when the air bag housing 70 is continuously slid, the air bag housing 70 is inserted into the air bag door 60 such that the fastening pieces 192 correspond to the fastening holes 194. Then, the fastening pieces 192 reach the fastening holes 194 by the restoring force of the coil springs 196. Thereby, the air bag door 60 and the air bag housing 70 are connected.

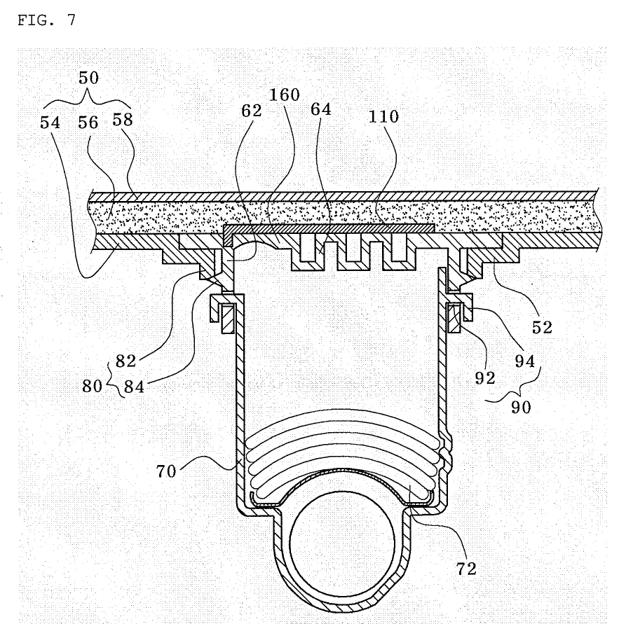

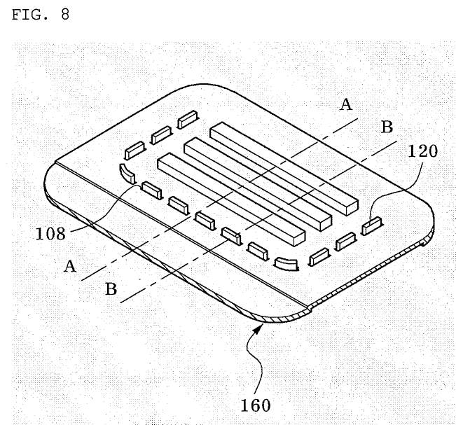

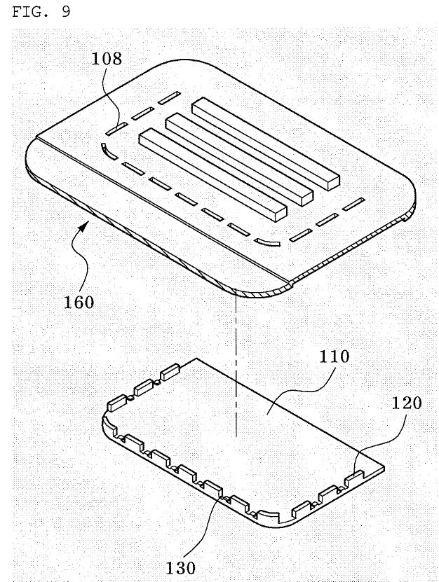

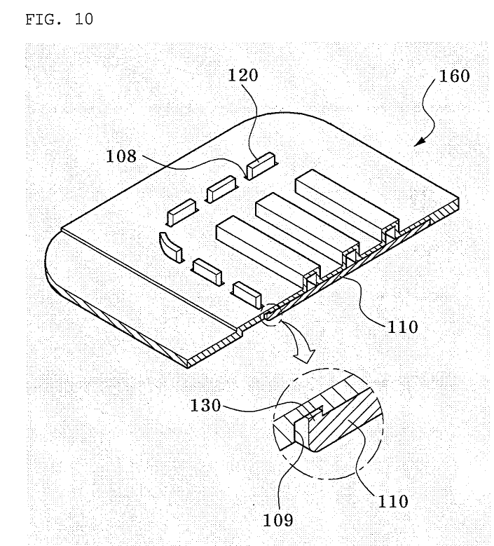

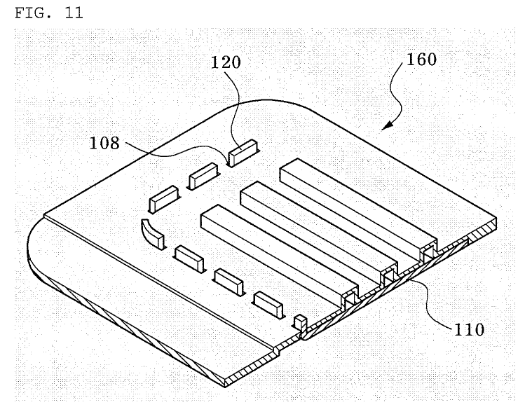

FIG. 7 is a longitudinal-sectional view of an air bag module for vehicles in accordance with a third embodiment of the present invention, FIG. 8 is a perspective view of an essential portion of a door of the air bag module for vehicles in accordance with the third embodiment of the present invention, FIG. 9 is an exploded perspective view of FIG. 8, FIG. 10 is a longitudinal-sectional view taken along the line A-A of FIG. 8, and FIG. 11 is a longitudinal-sectional view taken along the line B-B of FIG. 8.

With reference to FIGS. 7 to 11, an air bag module for vehicles in accordance with the third embodiment is characterized in an air bag door 160.

The air bag door 160 of the air bag module for vehicles of the third embodiment is provided with fracture holes 108 formed therethrough for tearing the air bag door 160.

Preferably, the fracture holes 108 are continuously formed and spaced at regular intervals along a C-shaped route.

Thus, when the air bag 72 is spread, the air bag door 160 is torn off along the fracture holes 108, thereby being opened.

Particularly, the air bag door 160 is made of plastic, and thus is easily deformed or damaged.

Therefore, a reinforcing member 110 is formed integrally on the upper or lower surface of the air bag door 160.

The reinforcing member 110 is made of a metal, and thus reinforces the air bag door 160.

Preferably, the reinforcing member 110 has a plate shape, and is formed integrally throughout the surface of the air bag door 160.

Particularly, the reinforcing member 110 is over-molded on the surface of the air bag door 160.

Over-molding is a technique that a metal insert product is covered with a plastic injection molded product and then injection molded. The over-molding is well known to those skilled in the art, and a detailed description thereof will be thus omitted.

Thus, the air bag door 160 made of plastic is laid on the reinforcing member 110 made of a metal to form a double-layered structure, thereby having an improved rigidity. Thus, it is possible to prevent the air bag door 160 from being warped, deformed, and damaged.

Preferably, the reinforcing member 110 is formed on the upper surface of the air bag door 160, being opposite to the lower surface of the air bag door 160 facing the air bag 72, so as not to collide directly with the air bag 72.

Further, preferably, the reinforcing member 110 is insert injection molded such that extension members 120 are extended integrally from the reinforcing member 110 and inserted into the fracture holes 108.

The extension members 120 prevent the arbitrary separation of the reinforcing member 110 and the air bag door 160.

The extension members 120 are insert injection molded so as to be formed in an L-shape and be protruded to the outside through the fracture holes 108, thus firmly attaching the reinforcing member 110 to the air bag door 160.

Preferably, the extension members 120, which are extended from integrally the edge of the reinforcing member 110, are prepared in the same number as that of the fracture holes 108, so as to be insert injection molded into all the fracture holes 108.

Seam lines 109 are caved in the air bag door 160 between the fracture holes 108.

The seam lines 109 are coplanarly formed on the air bag door 160.

Further, bending members 130 are extended integrally from the reinforcing member 110 so as to be inserted into the seam lines 109.

The bending members 130 are integrally injection molded under the condition that they are inserted into the seam lines 109, thus serving to firmly attach the reinforcing member 110 to the air bag door 160.

Preferably, the bending members 130 are injection molded under the condition that they are inserted into all the seam lines 109 between the fracture holes 108.

Further, preferably, the extension members 120 and the bending members 130 are simultaneously extended from the reinforcing member 110.

The injection molding is a general technique, and a detailed description thereof will be thus omitted.

Although the preferred embodiments of the present invention have been disclosed for illustrative purposes, those skilled in the art will appreciate that various modifications, additions and substitutions are possible.

For examples, although an air bag module for vehicles is exemplarily described, the present invention may be applied to air bag modules for other systems.

Accordingly, the scope and sprit of the present invention is defined by the accompanying claims.

As apparent from the above description, the present invention provides an air bag module for vehicles, in which an air bag door and an air bag housing are connected by a connection unit, and the air bag door and an instrument panel are connected by a mounting unit, thereby reducing the number of parts required to install the air bag module and thus lowering a unit cost.

Since the air bag door expands and contracts corresponding to the expansion and contraction of the instrument panel due to crease portions formed in the outer wall of the air bag door, the air bag module for vehicles of the present invention prevents the area of the instrument panel, in which the air bag door is located, from being deformed, and allowing the instrument panel to maintain a fine external appearance.

Since the air bag door made of plastic and a reinforcing member made of a metal are integrally formed by over-molding, the air bag module for vehicles of the present invention prevents the air bag door from being damaged or deformed. Further, extension members and bending members are extended from the reinforcing member, and are respectively insert injection molded into fracture holes and seam lines, thus firmly connecting the reinforcing member to the air bag door.

What is claimed is:

1. An air bag module for vehicles comprising:
an instrument panel provided with a receipt hole formed therethrough;
an air bag door installed at the receipt hole;
an air bag housing, into which an air bag is put, installed in the receipt hole;
an extension portion protruded from the air bag door to the inside of the receipt hole;
a connection unit installed between the extension portion and the air bag housing for connecting the air bag door and the air bag housing; and
a mounting unit installed between the air bag door and the receipt hole for fastening the air bag door in the receipt hole.

2. The air bag module according to claim 1, wherein a plurality of crease portions, which is concave, is formed in the upper surface of the air bag door.

3. The air bag module according to claim 2, further comprising:
fracture holes causing the air bag door to be torn off, when the air bag is spread; and
a reinforcing member over-molded on the upper or lower surface of the air bag door.

4. The air bag module according to claim 3, wherein the reinforcing member is made of a metal.

5. The air bag module according to claim 3, wherein extension members are extended integrally from the reinforcing member, and are insert injection molded under the condition that they are inserted into the fracture holes.

6. The air bag module according to claim 3, wherein:
seam lines are caved in the air bag door between the neighboring fracture holes; and
and bending members are extended integrally from the reinforcing member, and are insert injection molded under the condition that they are inserted into the seam lines.

7. The air bag module according to claim 1, wherein the mounting unit includes a protrusion obtained by inwardly bending the edge of the receipt hole, and a hook installed around the extension portion corresponding to the protrusion.

8. The air bag module according to claim 1, wherein the connection unit includes connection holes formed through the lower end of the extension portion, and connection protrusions formed on the air bag housing corresponding to the connection holes and inserted into the connection holes.

9. The air bag module according to claim 1, wherein the connection unit includes fastening pieces rotatably installed at the end of the air bag housing, coil springs installed on rotary shafts of the fastening pieces, and fastening holes formed through the inner wall of the air bag door corresponding to the fastening pieces.
